(19) United States
(12) Patent Application Publication
(10) Pub. No.: US 2021/0284842 A1
(43) Pub. Date: Sep. 16, 2021

(54) SILICONE MIXTURES WITH IMPROVED TEAR PROPAGATION RESISTANCE

(71) Applicant: SIKA TECHNOLOGY AG, Baar (CH)

(72) Inventors: André SAVOY, Rudolfstetten (CH); Manuel FRIEDEL, Zürich (CH); Andrea MÜLLER, Hendschiken (CH)

(73) Assignee: SIKA TECHNOLOGY AG, Baar (CH)

(21) Appl. No.: 16/323,329

(22) PCT Filed: Aug. 16, 2017
(86) PCT No.: PCT/EP2017/070745

§ 371 Date: Feb. 5, 2019

(30) Foreign Application Priority Data
Aug. 18, 2016 (EP) 16184716.5

(51) Int. Cl. C08L 83/06; C08K 3/36; C08K 3/011; C09D 183/06

(52) U.S. Cl. CPC C08L 83/06; C08K 3/36; C08K 2201/006; C09D 183/06; C08K 3/011

(57) ABSTRACT

A silicone composition including: at least two reactive polydiorganosiloxane polymers P1 and P2 that together account for 20% to 60% by weight, based on the overall silicone composition; at least one crosslinker for polydiorganosiloxanes, with a proportion of 0.5% to 5% by weight, based on the overall silicone composition; at least one catalyst, with a proportion of 0.001% to 0.1% by weight, based on the overall silicone composition; at least one optionally hydrophobized filler, selected from precipitated or fumed silica and ground or precipitated chalk, with a proportion of 10% to 70% by weight, based on the overall silicone composition, wherein the reactive polyorganosiloxane polymer P1 has a higher reactivity in the condensation crosslinking with the crosslinker than the reactive polyorganosiloxane polymer P2 and the molar ratio P1:P2 in the composition is between 0.1 and 15.

### TECHNICAL FIELD

The present invention relates to the field of silicone compositions as used as sealants and adhesives in particular.

### PRIOR ART

Silicone compositions have already long been known and are used particularly as adhesives and sealants in different applications. Both one-component, moisture-curing (RTV-1) silicone compositions and room temperature-crosslinking, two-component (RTV-2) silicone compositions are in wide use. Since silicone compositions are often used in the construction sector, they have to fulfill particular specifications with regard to their properties, especially mechanical properties. In Switzerland, for example, such specifications are issued by the Bundesamt für Bevölkerungsschutz [Federal Office for Civil Protection]. Among other demands, certain demands are also placed on the tear propagation resistance of silicone compositions, it being known that silicone compositions in particular have relatively low tear propagation resistances.

EP0649879 discloses silicone compositions containing a specific filler combination of precipitated silica surface-modified with hexamethyldisilazane and stearate-coated precipitated calcium carbonate, and also a tin catalyst. The use of these very specific fillers can improve the tear propagation resistance of the silicone composition.

The disadvantage of compositions according to EP0649879 is that these specific fillers are difficult to produce and hence costly.

EP2641934 likewise discloses silicone compositions with improved tear propagation resistance, this effect being achieved by a particular filler combination in conjunction with a particular catalyst combination.

The disadvantage of compositions as disclosed in EP2641934 is that these compositions have elevated viscosities and are therefore pumpable only with difficulty.

### SUMMARY OF THE INVENTION

It is therefore an object of the present invention to provide a silicone composition having improved tear propagation resistance which is realizable with standard inexpensive fillers as well and has low viscosity in conjunction with improved pumpability.

It has been found that, surprisingly, this object is achieved by silicone compositions as claimed in claim 1.

The use of at least two polydiorganosiloxane polymers of different reactivity in conjunction with at least one filler makes it possible to significantly improve the tear propagation resistance of the silicone composition without significantly increasing its viscosity. The compositions of the invention thus likewise have good pumpability.

Further aspects of the invention form the subject matter of further independent claims. Particularly preferred embodiments of the invention form the subject matter of the dependent claims.

### Ways of Executing the Invention

The present invention relates to a silicone composition comprising
at least two reactive polyorganosiloxane polymers P1 and P2 of the formula (I) that together account for 20% to 60% by weight, based on the overall silicone composition,

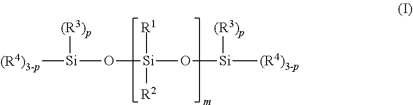

where the R¹, R² and R³ radicals are independently linear or branched, monovalent hydrocarbyl radicals which have 1 to 12 carbon atoms and optionally include one or more heteroatoms, and optionally one or more C—C multiple bonds and/or optionally cycloaliphatic and/or aromatic components;
the R⁴ radicals are independently hydroxyl groups or alkoxy, acetoxy or ketoxime groups which each have 1 to 13 carbon atoms and optionally include one or more heteroatoms, and optionally one or more C—C multiple bonds and/or optionally cycloaliphatic and/or aromatic components;
the index p has a value of 0, 1 or 2,
at least one crosslinker V for polydiorganosiloxanes, with a proportion of 0.5% to 5% by weight, based on the overall silicone composition,
at least one catalyst K, with a proportion of 0.001% to 0.1% by weight, based on the overall silicone composition,
at least one optionally hydrophobized filler F, selected from the group comprising precipitated or fumed silica and ground or precipitated chalk, with a proportion of 10% to 70% by weight, based on the overall silicone composition,
characterized in that
the reactive polyorganosiloxane polymer P1 has a higher reactivity in the condensation crosslinking with crosslinker V than the reactive polyorganosiloxane polymer P2 and the molar ratio P1:P2 in the composition is between 0.1 and 15.

Substance names beginning with “poly”, for example polydimethylsiloxane, in the present document refer to substances containing, in a formal sense, two or more of the functional groups that occur in their name, for example dimethylsiloxane groups, per molecule.

The term “polymer” in the present document firstly encompasses a collective of macromolecules that are chemically uniform but differ in relation to degree of polymerization, molar mass and chain length, said collective having been prepared by a poly reaction (polymerization, polyaddition, polycondensation). The term secondly also encompasses derivatives of such a collective of macromolecules from poly reactions, i.e. compounds which have been obtained by reactions, for example additions or substitutions, of functional groups on defined macromolecules and which may be chemically uniform or chemically nonuniform. The term thus further encompasses what are called prepolymers, i.e. reactive oligomeric preliminary adducts, the functional groups of which are involved in the structure of macromolecules.

“Molecular weight” refers to the molar mass (in g/mol) of a molecule or a molecule residue. “Average molecular weight” refers to the number-average molecular weight (Mₑ) of an oligomeric or polymeric mixture of molecules or molecule residues. It is typically determined by means of gel permeation chromatography (GPC) against polydimethylsiloxane as standard.

The term “viscosity” refers to the dynamic viscosity or shear viscosity, which is defined by the ratio between the shear stress and the shear rate (speed gradient) and is determined as described in DIN EN ISO 3219.

“BET surface area” refers to the surface area of filler particles which is measured by the BET method (named for Brunauer, Emmett and Teller) and using the method which is described in ISO 5794 (incorporating Annex D). A substance or composition is referred to as “storage-stable” or “storable” when it can be stored at room temperature in a suitable container over a prolonged period, typically over at least 3 months up to 6 months or more, without any change in its application or use properties to a degree of relevance for the use thereof as a result of the storage.

The terms “mass” and “weight” are used synonymously in this document. Thus a “percentage by weight” (% by weight) is a percentage mass fraction which unless otherwise stated relates to the mass (the weight) of the total composition or, depending on the context, of the entire molecule.

“Room temperature” refers to a temperature of 23° C.

All industry standards and official standards mentioned in this document, unless stated otherwise, relate to the version valid at the time of filing of the first application.

The at least two polydiorganosiloxanes P1 and P2 in the silicone composition of the invention are polydiorganosiloxanes of the formula (I).

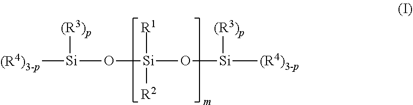

The R¹, R² and R³ radicals here are independently linear or branched, monovalent hydrocarbyl radicals which have 1 to 12 carbon atoms and optionally include one or more heteroatoms, and optionally one or more C—C multiple bonds and/or optionally cycloaliphatic and/or aromatic components. In particular, the R¹ and R² radicals are alkyl radicals having 1 to 5, especially 1 to 3, carbon atoms, preferably methyl groups. The R³ radicals are independently especially phenyl, vinyl or methyl groups.

The R⁴ radicals are independently hydroxyl groups or alkoxy, acetoxy or ketoxime groups which each have 1 to 13 carbon atoms and optionally include one or more heteroatoms, and optionally one or more C—C multiple bonds and/or optionally cycloaliphatic and/or aromatic components.

The index p has a value of 0, 1 or 2, especially 0 or 1.

In addition, the index m is preferably chosen such that the polydiorganosiloxane P1 at a temperature of 23° C. has a viscosity of 10 to 10000 mPa·s, especially of 25 to 7500 mPa·s, preferably of 50 to 5000 mPa s, and the polydiorganosiloxane P2 at a temperature of 23° C. has a viscosity of 10′000 to 500′000 mPa·s, especially of 20000 to 250000 mPa·s, preferably of 30000 to 200000 mPa·s.

If the R⁴ radicals are ketoxime groups, they are preferably ketoxime groups each having 1 to 13 carbon atoms and the index p is especially a value of 0. Preferred ketoxime groups here are dialkyl ketoxime groups wherein the alkyl groups each have 1 to 6 carbon atoms. Preferably, the two alkyl groups of the dialkyl ketoxime groups are independently methyl, ethyl, n-propyl, isopropyl, n-butyl or isobutyl groups. Particular preference is given to those cases in which one alkyl group of the dialkyl ketoxime is a methyl group and the other alkyl group of the dialkyl ketoxime is a methyl, ethyl or isobutyl group. Most preferably, the ketoxime group is an ethyl methyl ketoxime group.

Preferably, the R⁴ radicals are hydroxyl groups and the index p is a value of 2.

Suitable polydiorganosiloxanes as shown in formula (I) are known and commercially available. Polydiorganosiloxanes of this kind are also prepared in a known manner as described, for example, in EP0658588.

For the use of the invention, the reactive polydiorganosiloxane polymer P1 must have higher reactivity in the condensation crosslinking with crosslinker V than the reactive polydiorganosiloxane polymer P2.

This difference in the reactivity of P1 and P2 can be achieved in two ways: The first, more preferred case involves two polydiorganosiloxanes having the same functionalization that have a distinct difference in chain length and hence a distinctly different molecular weight. For example and with preference, these are two hydroxyl-terminated polydiorganosiloxanes, more preferably two hydroxyl-terminated polydimethylsiloxanes. Alternatively, these may be two siloxanes of distinctly different molecular weight that both have the same end groups, e.g. alkoxy, acetoxy or ketoxime end groups.

The effect of a distinctly different molecular weight is that the smaller polydiorganosiloxane firstly has a distinctly lower viscosity and a distinctly higher molecular mobility within a composition, which is affected, for example, by lower chain interlooping or entanglement and a smaller molecular volume. Secondly, the smaller polydiorganosiloxane has a higher density of reactive end groups.

“Distinctly different” in relation to molecular weight means in this case that the molecular weight ranges must in no way be adjacent or even overlap, and the upper limit of the molecular weight range of P1 is preferably lower at least by a factor of 2, preferably at least by a factor of 5, than the lower limit of the molecular weight range of P2.

More preferably, the more reactive polydiorganosiloxane polymer P1 has an average molecular weight Mₙ of at most 3000 g/mol and the reactive polydiorganosiloxane polymer P2 an average molecular weight Mₙ of at least 50000 g/mol.

More particularly, the reactive polydiorganosiloxane polymer P1 preferably has a molecular weight of between 500 and 2500 g/mol and the reactive polydiorganosiloxane polymer P2 preferably has a molecular weight of between 50000 and 250000 g/mol.

A second means of establishing different reactivities in polymers P1 and P2 lies in the use of different reactive end groups. The difference here may lie in the fact that the number of hydrolyzable bonds in the end groups, for example, is different. For example, a polydiorganosiloxane polymer having trimethoxysilyl end groups is more reactive than one having methyldimethoxysilyl end groups. The difference may also be that the nature of the hydrolyzable bonds is chemically different. For example, a polydiorganosiloxane having a trimethoxysilyl end group is more reactive than one having a more sterically demanding triethoxysilyl end group.

The nature and relative reactivity of such end groups are very well known to the person skilled in the art in the field of silicone chemistry.

It is also possible to use a mixed form of these abovementioned measures for the present invention, for example to use two polydiorganosiloxanes P1 and P2 having different molecular weight and simultaneously different reactive end groups.

The molar ratio of the two polydiorganosiloxane polymers P1 and P2 must be within a range in order to achieve the effect of the invention. The molar ratio of P1 to P2 in the overall composition must be between 0.1 and 15; the molar P1:P2 ratio is preferably between 0.5 and 10, more preferably between 1 and 5.

The one- or two-component silicone composition further comprises one or more monomeric silanes and/or oligomeric siloxanes as crosslinker V for the polyorganosiloxane, an oligomeric siloxane being a condensation product of monomeric silane crosslinkers. Monomeric silane crosslinkers and also oligomeric condensation products thereof are known as crosslinkers for silicone formulations.

Monomeric silane crosslinkers are generally silane compounds containing two or more, for example three or more and preferably 3 or 4, functional groups. Functional groups are understood here to mean especially groups that can react with functional groups of the polyorganosiloxane to form a bond, the reaction optionally being initiated by hydrolysis, alcoholysis or a different detachment reaction in the functional group of the polydiorganosiloxane and/or the crosslinker. The functional groups may be at any site in the silane crosslinker; they are preferably bonded to a silicon atom of the monomeric silane crosslinker.

Examples of functional groups that a monomeric silane crosslinker may have are alkoxy groups, such as C₁₋₅-alkoxy groups, preferably methoxy, ethoxy or propoxy groups, acetoxy groups, amide groups, preferably N-alkylamide groups, especially N-methylbenzamide or N-methylacetamide groups, amine groups, preferably alkylated amine groups, for example cyclohexylamine, but especially dialkylated amine groups, for example N,N-diethylamine, halogen atoms, especially chlorine and/or bromine atoms, and hydrido substituents or oxime groups. As examples of oxime groups, reference is made to the preferred ketoxime groups described above. These functional groups are generally bonded directly to a silicon atom of the monomeric silane crosslinker.

Monomeric silane crosslinkers may have, for example, one of the following general formulae (II) to (IV):

(R⁶ [symbol] _{q}Si [symbol] R⁷)_{4-q} (II)

(R⁷)₃—Si—R⁸—Si—(R⁷)₃ (III)

N(H)ₙ(Si—(R⁷)₃)₃₋ₙ (IV)

The R⁶ radical here is independently a linear or branched, monovalent hydrocarbyl radical which has 1 to 12 carbon atoms and optionally includes one or more heteroatoms, and optionally one or more C—C multiple bonds and/or optionally cycloaliphatic and/or aromatic components. Preferred examples of R⁶ are alkyl groups having 1 to 5 carbon atoms, preferably methyl, ethyl or propyl, vinyl, aryl groups, such as phenyl, cycloalkyl groups, such as cyclohexyl, and substituted alkyl groups having 1 to 8 carbon atoms, preferably methyl, ethyl or propyl, which are functionalized with one or more substituents, such as optionally substituted amino (NH₂, NHR, NR₂, where R is independently alkyl, aryl or cycloalkyl), mercapto, glycidoxy, methacrylate, acrylate or carbamato.

The R⁷ radical is independently a hydroxyl group or an alkoxy, acetoxy or ketoxime group which in each case has 1 to 13 carbon atoms and optionally includes one or more heteroatoms, and optionally one or more C—C multiple bonds and/or optionally cycloaliphatic and/or aromatic components. Preferred ketoxime groups and alkoxy groups have already been described above.

In addition, the index q has a value of 0 to 4, with the proviso that, if q has a value of 3 or 4, at least q-2 R⁶ radicals each have at least one group reactive with the functional groups of the polydiorganosiloxane. In particular, q has a value of 0, 1 or 2, preferably a value of 0 or 1.

R⁸ is a divalent alkylene group, e.g. a C₁₋₆-alkylene group, especially methylene, ethylene or hexylene, an arylene group, such as phenylene, or a cycloalkylene group, preference being given to alkylene. The index n is 0, 1 or 2, preferably 1.

For the choice of at least one silane of the formulae (III)-(V) as crosslinker V for polydiorganosiloxanes, different demands on the silicone composition may be crucial. On the one hand, the reactivity of the silane plays an important role, preference being given in principle to more highly reactive silanes. On the other hand, toxicological reasons may also be crucial for the choice of crosslinker. For that reason, preference is given to tetraethoxysilane as crosslinker over tetramethoxysilane, for example, since the volatile alcohol cleavage products that form in the course of crosslinking are of greater toxicological concern in the latter case.

Specific examples of monomeric silane crosslinkers are methyltrimethoxysilane, chloromethyltrimethoxysilane, vinyltrimethoxysilane, phenyltrimethoxysilane, propyltrimethoxysilane, 3-mercaptopropyltrimethoxysilane, 3-aminopropyltrimethoxysilane, 3-methacryloyloxypropyltrimethoxysilane, 3-glycidoxypropyltrimethoxysilane, 2-aminoethyl-3-aminopropyltrimethoxysilane, 1,2-bis(trimethoxysilyl)ethane, bis(trimethoxysilylpropyl)amine, N-(n-butyl)-3-aminopropyltrimethoxysilane, N-cyclohexylaminomethyltrimethoxysilane, methacryloyloxymethyltrimethoxysilane, O-methylcarbamatomethyltrimethoxysilane or the corresponding compounds in which the methoxy group has been replaced by ethoxy, propoxy, oxime or ketoxime, for example methyltriethoxysilane, vinyltriethoxysilane, phenyltriethoxysilane, methyltripropoxysilane and phenyltripropoxysilane, and also, for example, bis(N-methylacetamido)methylethoxysilane, tris(methylethylketoximo)methylsilane, tris(methylethylketoximo)vinylsilane and tris(methylethylketoximo)phenylsilane. Further examples are tetramethoxysilane, tetraethoxysilane, tetra-n-butoxysilane and tetra-n-propoxysilane.

Oligomeric siloxanes suitable as crosslinker V are condensation products of one or more monomeric silane crosslinkers of this kind. Oligomeric siloxanes of this kind are known and commercially available, for example under the Dynasylan® 1146 or Dynasylan® 6490 trade names from Evonik Degussa GmbH. Oligomers of functional silanes are 3-dimensional compounds of complicated structure. The oligomeric silane may be formed, for example, from hydrolysis and condensation of one or more identical or different monomeric silane crosslinkers.

An oligomeric siloxane of this kind contains functional groups that come from the monomeric silane crosslinkers used for the synthesis thereof. For example, a first condensation of two tetramethoxysilane molecules leads to a dimer containing six functional groups; one functional group in each molecule forms the linkage through condensation. As already set out, the structure of the oligomers formed may be complicated. The number of functional groups in the oligomer can vary according to the degree of condensation, nature of condensation and monomeric silane crosslinker used, but is at least 2, but generally greater, e.g. 4 or more.

For example, suitable oligomeric siloxanes are hexamethoxydisiloxane, hexaethoxydisiloxane, hexa-n-propoxydisiloxane, hexa-n-butoxydisiloxane, octaethoxytrisiloxane, octa-n-butoxytrisiloxane and decaethoxytetrasiloxane.

The degree of condensation of the oligomeric siloxane, i.e. the number of monomeric silane crosslinkers fused to one another, may vary within wide ranges according to the end use, but may, for example, be within the range from 2 to 200 and preferably from 4 to 50. It will be apparent that the degree of condensation, especially in the case of higher degrees of condensation, is frequently an average.

The crosslinker V used for the silicone composition of the invention may of course also be any mixture of the aforementioned silanes.

The proportion of the crosslinker V for polydiorganosiloxanes is preferably 0.5% to 4.5% by weight, especially 0.6% to 4% by weight, preferably 0.7% to 3% by weight, of the overall silicone composition.

The silicone composition of the invention further comprises, in a proportion of 0.001% to 0.1% by weight, based on the overall silicone composition, at least one catalyst K for the crosslinking of polydiorganosiloxanes, where the catalyst K comprises at least one complex of an element selected from groups 1, 4, 8, 9, 10, 12, 13, 14 and 15 of the Periodic Table, especially a tin complex or titanium complex or a mixture thereof. A catalyst for the crosslinking of polydiorganosiloxanes is capable of catalyzing the hydrolysis and/or condensation of hydrolyzable and/or hydrolyzed silanes, siloxanes and polysiloxanes. In the silicone compositions, these reactions lead, as described in the present invention, to crosslinking of the polydiorganosiloxane chains with the aid of the crosslinkers V present. The compounds suitable as catalyst may, for example, be organic molecules, for instance basic heterocycles, or metal complexes.

The condensation catalyst is preferably an organotin compound or a titanate or organotitanate. These are commercially available. It is also possible and even preferred in certain cases to use mixtures of different catalysts.

Preferred organotin compounds are dialkyltin compounds as selected, for example, from the group consisting of dimethyltin di-2-ethylhexanoate, dimethyltin dilaurate, di-n-butyltin diacetate, di-n-butyltin acetoacetonate, di-n-butyltin dioxide, di-n-butyltin di-2-ethylhexanoate, di-n-butyltin dicaprylate, di-n-butyltin di-2,2-dimethyloctanoate, di-n-butyltin dilaurate, di-n-butyltin distearate, di-n-butyltin dimaleate, di-n-butyltin dioleate, di-n-octyltin diacetate, di-n-octyltin acetoacetonate, di-n-octyltin dioxide, di-n-octyltin di-2-ethylhexanoate, di-n-octyltin di-2,2-dimethyloctanoate, di-n-octyltin dimaleate and di-n-octyltin dilaurate.

Titanates or organotitanates refer to compounds having at least one ligand bonded to the titanium atom via an oxygen atom. Suitable ligands bonded to the titanium atom via an oxygen-titanium bond are, for example, those selected from an alkoxy group, sulfonate group, carboxylate group, dialkylphosphate group, dialkylpyrophosphate group and acetylacetonate group. Preferred titanates are, for example, tetrabutyl or tetraisopropyl titanate. Further suitable titanates have at least one polydentate ligand, also called chelate ligand. In particular, the polydentate ligand is a bidentate ligand.

Suitable titanates are commercially available, for example, under the Tyzor® AA, GBA, GBO, AA-75, AA-65, AA-105, DC, BEAT, IBAY trade names, commercially available from Dorf Ketal, or under the Tytan™ PBT, TET, X85, TAA, ET, S2, S4 or S6 trade names, commercially available from Borica.

Preference is also given to zirconates, bismuthates and aluminates. Suitable zirconates are commercially available, for example, under the Tyzor® NBZ, NPZ, TEAZ, 212, 215, 217, 223 trade names from Dorf Ketal or under the K-Kat 4205 or K-Kat XC-6212 trade names from King Industries. Bismuthates that are the most preferred are bismuth carboxylates. The bismuth carboxylates are preparable from Bi(III) compounds with the organic acids R—COOH by the literature methods or are obtainable as commercial products under the respective brand names, such as bismuth trioctoate or bismuth trineodecanoate, for example under the brand names Borchi® Kat (from Borchers GmbH) or Tegokat® (from Goldschmidt TIB GmbH), Neobi® 200, from Shepherd, or Coscat®, from Caschem.

Further suitable bismuthates are available, for example, under the K-Kat 348 and K-Kat XC-8203 brand name from King Industries.

A suitable aluminate is available, for example, under the K-Kat 5218 brand name from King Industries.

It is of course possible and in certain cases even preferable to use mixtures of different complexes of an element selected from groups 1, 4, 8, 9, 10, 12, 13, 14 and 15 of the Periodic Table of the Elements as catalyst K. It may also be preferable to combine at least one complex with organic catalysts, for example amines.

The proportion by weight of catalyst K is preferably 0.1 to 6 parts by weight, especially 0.2 to 5 parts by weight, preferably 0.5 to 3 parts by weight, based on 100 parts by weight of polydiorganosiloxane P1 and P2 in the overall silicone composition.

The silicone composition of the invention further comprises at least one optionally hydrophobized filler F, selected from the group comprising precipitated or fumed silica and ground or precipitated chalk, with a proportion of 10% to 70% by weight, based on the overall silicone composition. Suitable fillers are all fillers known to the person skilled in the art in the field of formulation of silicone compositions, selected from the group comprising precipitated or fumed silica and ground or precipitated chalk.

A preferentially suitable chalk filler is calcium carbonate, for example in the form of limestone, chalk, shell lime or marble. The calcium carbonate here may have been obtained from natural sources, for example marble quarries, or produced by known methods, for example precipitation reactions. Natural calcium carbonate may contain proportions of further minerals, e.g. magnesium carbonate. Moreover, the calcium carbonate may have been ground and it may be in untreated or modified form, especially in surface-treated, i.e. hydrophobized, form. The surface treatment can be effected, for example, by treatment with fatty acids, especially stearates, preferably with calcium stearate. It is of course also possible to use mixtures of different calcium carbonates.

Preferably, the silicone composition of the invention comprises at least one chalk, especially at least one ground chalk having a BET surface area of 5 to 50 m²/g and preferably a median particle size d50 of 1 to 10 μm.

The basis for the figure for the particle size d50 is that 50% by weight of the particles have a size less than or equal to the value specified. The particle size d50 can typically be determined by laser light scattering in accordance with standard ISO 13320:2009, for example with the CILAS 920 instrument from CILAS.

A further preferred filler is silica, especially with a BET surface area of 50 to 300 m²/g, preferably of 100 to 255 m²/g.

Suitable silicas are precipitated or fumed silicas that may have been surface-hydrophobized or may be in untreated, i.e. hydrophilic, form.

Suitable hydrophobized silicas are typically siliconized and/or silanized silicas that then have a carbon content of 0.6% to 6.5% by weight, based on the total weight of the silica. Suitable silicas may alternatively be in untreated, i.e. hydrophilic, form. It is additionally also possible to use mixtures of different silicas.

The at least one filler F present in the composition of the invention affects both the rheological properties of the uncured composition and the mechanical properties and surface characteristics of the cured composition. It is possible and even advantageous in preferred embodiments to combine different fillers in the silicone composition of the invention. These may be different fillers of the invention, selected from the group comprising precipitated or fumed silica and ground or precipitated chalk, or at least one of the aforementioned with one or more further fillers.

Examples of suitable further fillers are organic or inorganic fillers that may have been coated with fatty acids, especially stearic acid, calcined kaolins, aluminas, aluminum hydroxides, carbon black, especially industry produced carbon black, aluminum silicates, magnesium aluminum silicates, zirconium silicates, quartz flour, cristobalite flour, diatomaceous earth, mica, iron oxides, titanias, zirconias, gypsum, annaline, barium sulfate, boron carbide, boron nitride, graphite, carbon fibers, zeolites, glass fibers or glass beads, the surface of which may have been treated with a hydrophobizing agent. Preferred further fillers are calcined kaolins, carbon black, and flame-retardant fillers such as hydroxides or hydrates, especially hydroxides or hydrates of aluminum, preferably aluminum trihydroxide.

A very particularly preferred embodiment of the silicone composition of the invention is characterized in that the filler F comprises two fillers F1 and F2, both selected from the group comprising precipitated or fumed silica and ground or precipitated chalk, where one filler F1 has a BET surface area of between 5 and 50 m²/g and the other filler F2 a BET surface area of between 50 and 300 m²/g.

A very particularly preferred embodiment comprises, as F2, at least one silica having a BET surface area of 50 to 300 m²/g and, as F1, at least one chalk having a BET surface area of 5 to 50 m²/g, preferably 10 to 25 m²/g, and preferably an average particle size d50 of 10 to 1000 nm.

A total amount of filler F in preferred embodiments of the silicone composition of the invention is typically in the range from 10% to 70% by weight, preferably 15% to 60% by weight, more preferably 20% to 50% by weight, based on the total weight of the composition.

The silicon composition of the invention may optionally comprise further constituents.

Additional constituents of this kind are especially auxiliaries, for example adhesion promoters, processing auxiliaries, leveling aids, stabilizers, dyes, pigments, plasticizers, fragrances, biocides, thixotropic agents, rheology modifiers, phosphates, inhibitors, heat stabilizers, antistats, flame retardants, free-radical scavengers, waxes and other commonly used raw materials and additives that are known to the person skilled in the art.

Any or all of the abovementioned auxiliaries or others that are not mentioned may be present in the silicone composition of the invention, and every single one of the auxiliaries additionally present is preferably present with a proportion of less than 25 parts by weight, more preferably less than 15 parts by weight, most preferably less than 10 parts by weight, based on 100 parts by weight of all polydiorganosiloxanes P1 and P2 present in the composition.

When optional constituents of this kind are used, it is advantageous to select all the constituents mentioned that may be present in the silicone composition so as to not adversely affect the storage stability of the silicone composition by virtue of the presence of such a constituent, meaning that the properties of the composition, especially the application and curing properties, are altered only slightly, if at all, in the course of storage. This means that reactions that lead to chemical curing of the silicone composition described do not occur to a significant degree during storage. It is therefore especially advantageous that the constituents mentioned contain, or release in the course of storage, no water or traces of water at most. It may therefore be advisable to subject certain constituents to chemical or physical drying before mixing them into the composition.

Suitable plasticizers for the silicone composition of the invention are especially trialkylsilyl-terminated polydialkylsiloxanes, especially trimethylsilyl-terminated polydimethylsiloxanes. Preference is given to trimethylsilyl-terminated polydimethylsiloxanes having viscosities between 1 and 10000 mPa·s. Particular preference is given to viscosities between 10 and 1000 mPa·s. However, it is also possible to use trimethylsilyl-terminated polydimethylsiloxanes in which some of the methyl groups have been replaced by other organic groups, for example phenyl, vinyl or trifluoropropyl. Even though particular preference is given to using linear trimethylsilyl-terminated polydimethylsiloxanes as plasticizers, it is also possible to use compounds that are branched. It is also possible, rather than the polysiloxane plasticizers, to use organic compounds, for example particular hydrocarbons or mixtures thereof, as plasticizers. Hydrocarbons of this kind may be aromatic or aliphatic. In the selection, it should be ensured particularly that these hydrocarbons have low volatility and sufficient compatibility with the other constituents of the silicone composition.

The proportion of the plasticizer is preferably 2% to 35% by weight, especially 5% to 25% by weight, of the overall silicone composition.

Particularly suitable adhesion promoters are alkoxysilanes that have preferably been substituted by functional groups. The functional group is, for example, an aminopropyl, glycidoxypropyl or mercaptopropyl group. Preference is given to amino-functional groups. The alkoxy groups of such silanes are usually a methoxy or ethoxy group. Particular preference is given to aminopropyltrimethoxysilane, 3-aminopropyltriethoxysilane, 3-(2-aminoethyl)aminopropyltriethoxysilane and 3-mercaptopropyltriethoxysilane. It is also possible to use a mixture of adhesion promoters. Further suitable adhesion promoters are, for example, also amino-functional alkylsilsesquioxanes such as amino-functional methylsilsesquioxane or amino-functional propylsilsesquioxane, alkoxylated alkyleneamines, especially ethoxylated and/or propoxylated alkylenediamines, and further, especially substituted, oligomers, polymers or copolymers based on polyalkylene glycols. It will be clear to the person skilled in the art that it is possible in the case of use of silanes as adhesion promoters that these may be in partly or fully hydrolyzed form according to the conditions, for example in the presence of moisture. It is also known to the person skilled in the art that, in the presence of such partly or fully hydrolyzed silanes, condensation reactions can result in formation of oligomeric siloxanes, especially to give dimers and/or trimers.

The proportion of the adhesion promoter is preferably 0.1% to 15% by weight, especially 0.5% to 10% by weight, preferably 1% to 5% by weight, of the overall two-component silicone composition.

The silicone composition of the invention may take the form of a one-component or two-component composition.

If the silicone composition is a one-component silicone composition, it should especially be such that it crosslinks under the influence of heat or moisture. One-component silicone compositions that are most preferred crosslink at room temperature under the influence of moisture, especially of air humidity, the crosslinking being effected by condensation of silanol groups to form siloxane bonds.

In the case of a one-component silicone composition of the invention, the silicone composition is preferably formulated such that, after storage at 23° C. in a plastic cartridge for 12 h, expression through a die having internal diameter 3 mm and an expression rate of 60 mm/min requires an expression force of between 300 N and 1300 N, preferably 400 N and 1200 N, more preferably between 500 N and 1000 N.

If the silicone composition is a two-component composition, it is especially a two-component silicone composition consisting of a component A and a component B, wherein the polydorganosiloxane, the crosslinker and the catalyst or accelerator system composed of organotin compound and complex are divided between the two components such that the crosslinking reaction sets in only on or after mixing of the two components.

More particularly, the two-component silicone composition consists of a component A comprising
the at least two reactive polydiorganosiloxane polymers P1 and P2 that together account for 20% to 60% by weight, based on the overall silicone composition,
the at least one optionally hydrophobized filler F, selected from the group comprising precipitated or fumed silica and ground or precipitated chalk, with a proportion of 10% to 70% by weight, based on the overall silicone composition;
   and a component B comprising
the at least one crosslinker V for polydiorganosiloxanes, with a proportion of 0.5% to 5% by weight, based on the overall silicone composition,
the at least one catalyst K, with a proportion of 0.001% to 0.1% by weight, based on the overall silicone composition.

Both component A and component B of the two-component silicone composition described are produced and stored with exclusion of moisture. Separately from one another, the two components are storage-stable, meaning that they can be stored in a suitable package or arrangement over a period of several months up to a year or longer without any change in their use properties or in their properties after curing to a degree of relevance for their use. Typically, the storage stability is ascertained by the measurement of the viscosity or of the reactivity over time.

In the application of the two-component silicone composition, components A and B are mixed with one another, for example by stirring, kneading, rolling or the like, but especially by means of a static mixer, which results in curing of the composition. The two-component silicone composition is especially cured at room temperature.

More particularly, silicone formulations of the invention can be processed with standard equipment for pumping, mixing and dosing of RTV-2 silicones, for example hydraulically operated scoop pumps such as Reinhardt-Technik Ecostar 250.

If the silicone composition of the invention is a two-component silicone composition, this is especially used in such a way that the weight ratio of component A to component B is 1:1, especially from 3:1 to 15:1, preferably from 7:1 to 13:1.

As reaction products of the condensation reaction, the crosslinking of the silicone composition especially also gives rise to compounds of the formula HO—R⁴ where R⁴ has already been described above. Preferably, these by-products of the condensation reaction are compounds that impair neither the composition nor the substrate to which the composition is applied. Most preferably, the reaction product of the formula HO—R⁴ is a compound that volatilizes readily out of the crosslinking or already crosslinked composition.

The present invention further relates to the use of a silicone composition as described above as adhesive, sealant, coating or casting compound.

The present invention further relates to a cured silicone composition obtainable from a one-component silicone composition as described above, especially by reaction with moisture, or from a likewise above-described two-component silicone composition by mixing component A with component B.

The present invention further relates to the use of two reactive polydiorganosiloxane polymers P1 and P2, where the reactive polyorganosiloxane polymer P1 has a higher reactivity in condensation crosslinking with a crosslinker V for polydiorganosiloxanes than the reactive polyorganosiloxane polymer P2 and the molar ratio P1:P2 in the composition is between 0.1 and 15, together with at least one filler F selected from the group comprising precipitated or fumed silica and ground or precipitated chalk, with at least one crosslinker V, and with a catalyst K for increasing the tear propagation resistance of silicone compositions.

The present invention further relates to the use of two reactive polydiorganosiloxane polymers P1 and P2, where the reactive polyorganosiloxane polymer P1 has a higher reactivity in condensation crosslinking with a crosslinker V for polydiorganosiloxanes than the reactive polyorganosiloxane polymer P2 and the molar ratio P1:P2 in the composition is between 0.1 and 15, together with at least one filler F, where the filler F is a filler combination of F1 and F2, comprising, as F2, at least one filler, preferably a silica, having a BET surface area of 50 to 300 m²/g and, as F1, at least one filler, preferably a chalk, having a BET surface area of 10 to 25 m²/g and preferably an average particle size d50 of 10 to 1000 nm, with at least one crosslinker V, and with a catalyst K for increasing the tear propagation resistance of silicone compositions.

It is a particular advantage of the present invention that the formulation of one- and two-component silicone compositions with improved tear propagation resistance is now possible, using, as fillers, both natural and precipitated chalks that may be present together with fumed and precipitated silicas which may be treated or untreated. By contrast with the prior art, it is thus possible to use a distinctly extended range of fillers, especially also those that are particularly inexpensive. Furthermore, the compositions thus produced are of extremely low viscosity and have good pumpability.

The compositions of the invention in the cured state especially have tear propagation resistance (abbreviated to “TPR”, measured to DIN ISO 34-1 on type C specimens) of at least 3 N/mm, preferably at least 4 N/mm, more preferably at least 5 N/mm.

The viscosities of the uncured one-component compositions of the invention and the mixed viscosities of the uncured two-component compositions immediately after the components have been mixed are, at 23° C. and a shear rate of 0.89 s⁻¹, especially below 3000 Pa·s, preferably below 2500 Pa·s.

A two-component composition of the invention can be used as adhesive or sealant in a method of bonding or joining substrates, which enables accelerated curing of the adhesive or sealant. The method of the invention comprises

a) the mixing of component B into component A to obtain a mixture,
b) the application of the mixture to a substrate and contacting of the mixture applied to the substrate with a further substrate in order to obtain an adhesive bond between the substrates, or the introducing of the mixture into a gap between two substrates in order to obtain a join between the substrates, and
c) the curing of the mixture,
wherein the mixing-in in step a) is conducted before or during the application or introduction in step b).

For the one-component compositions of the invention, the same application steps are effected, naturally with the absence of the mixing of the components.

The components of the two-component composition of the invention are stored separately from one another for storage. The mixing of components A and B in step a) can be effected in a customary manner, for example by stirring component B into component A, which can be effected manually or with the aid of a suitable stirring apparatus, for example with a static mixer, dynamic mixing, Speedmixer, dissolver etc. For the application or introduction, the two components can also be expressed from the separate storage containers, for example with gear pumps, and mixed. The mixing can be effected, for example, in the conduits or nozzles for the application or introduction or directly on the substrate or in the gap.

The mixing-in in step a) can thus be conducted before or during the application or introduction in step b). The mixing should be effected relatively shortly before the further processing since the mixing commences the curing process.

The mixed viscosity of the two components A and B, i.e. the viscosity established during and immediately after the mixing of the two components A and B, at 23° C. and a shear rate of 0.89 s⁻¹, is especially below 3000 Pa·s, preferably below 2500 Pa·s. Thus, easy pumpability of the mixture for application remains assured.

Application to a substrate or introduction into a gap between substrates in step b) can be effected in a customary manner, for example manually or in an automated process with the aid of robots. On bonding, the substrate provided with the mixture is contacted with a further substrate, optionally under pressure, in order to obtain an adhesive bond between the substrates. Thereafter, the mixture is left to cure in step c), usually at room temperature, in order to achieve the bonding or joining of the substrates. In this way, the adhesive-bonded or joined substrates of the invention are obtained with the cured mixture of components A and B as adhesive or sealant material.

The substrates to be bonded, coated or joined may be of the same material or a different material. It is possible to bond, seal, coat or join any customary materials with the two-component composition of the invention. Preferred materials for coating, sealing, bonding or joining are glass, glass ceramic, metals, for example aluminum, copper, steel or stainless steel, concrete, mortar, rocks, for example sandstone, brick, tile, ceramic, gypsum, natural rocks such as granite or marble and calcareous sandstone, asphalt, bitumen, plastics, for example polyolefins, PVC, Tedlar, PET, polyamide, polycarbonate, polystyrene or poly(meth)acrylate, polyester, epoxy resin and composite materials such as CFRP, and painted or varnished surfaces.

The one- or two-component silicone formulations of the invention, preferably in the form of an RTV silicone, are especially suitable as elastic sealants and adhesives, coatings or potting compounds. A suitable field of use is, for example, the bonding, coating or sealing of articles made of glass, metal, e.g. aluminum, copper or stainless steel, or plastic, e.g. PVC, polyamide, polycarbonate or PET, and other materials as described above. The silicone formulations of the invention are more preferably used as adhesives or sealants, for example in the following sectors: construction, for example window and facade fitting, the sanitary sector, the automotive sector, solar power, wind power, white, brown or red goods, facade and window construction, electronics, and boat- and shipbuilding.

### EXAMPLES

Working examples are adduced hereinafter, which are intended to elucidate the invention described in detail. It will be appreciated that the invention is not restricted to these described working examples.

### Preparation of the Silicone Compositions

Raw materials used (the raw materials mentioned in the tables are listed hereinafter):
OH-terminated polydimethylsiloxane (PDMS) of viscosity 80 Pa·s and of average molar mass Mₙ 70000 g/mol (“OH-PDMS 1”, used as polymer P2) can be sourced from Wacker under the Polymer FD 80 trade name. OH-terminated PDMS of average molar mass Mₙ 2000 g/mol (“OH-PDMS 2”, used as polymer P1) can be sourced from Wacker under the Polymer X 345 trade name. Alkoxysilane-terminated polydimethylsiloxane (PDMS) of viscosity 80 Pa·s and of average molar mass Mₙ 70000 g/mol (“OR-PDMS 3”, used as polymer P2) can be sourced from Wacker under the Polymer AL100 trade name. Alkoxysilane-terminated polydimethylsiloxane (PDMS) of viscosity 9 Pa·s and of average molar mass Mₙ 30000 g/mol (“OR-PDMS 4”, used as polymer P1) can be sourced from Wacker under the Polymer AL08 trade name. OH-terminated polydimethylsiloxane (PDMS) of viscosity 120 Pa·s (“OH-PDMS 5”, used as polymer P2) can be sourced from Wacker. OH-terminated PDMS of viscosity 6 Pa·s and of average molar mass Mₙ 31000 g/mol (“OH-PDMS 6”, used as polymer P1) can be sourced from Wacker. (CH₃)₃Si-terminated PDMS of viscosity 100 mPa·s (“PDMS oil”) can be sourced from Wacker under the AK 100 Silicone Fluid trade name. Vinyl-terminated PDMS (“Vinyl-PDMS”) of viscosity 20 Pa·s can be sourced under the Flexosil® VinylFluid 20000 trade name from BRB. Precipitated chalk (“PCC”, stearate-coated and having a BET surface area of 20 m²/g) can be sourced from Solvay under the Winnofil® or Socal® trade names. Natural ground chalk (“GCC”) can be sourced from Imerys under the Carbital® trade name. Precipitated silicas (“Silica 1”, with a BET surface area of 90 m²/g) can be sourced from Evonik under the Sipernat® trade name or from Rhodia under the Zeosil® trade name. Fumed silicas (“Silica 2”, with a BET surface area of 146 m²/g) can be sourced from Cabot under the Cabosil® trade name or from Evonik under the Aerosil® trade name or from Wacker under the HDK® trade name. Silanes and siloxanes can be sourced from Evonik under the Dynasylan® trade names or from Wacker under the Geniosil® trade name (e.g. tetraethoxysilane “TEOS”, oligomers thereof “TEOS-oligomer”, bis(triethoxysilane)-functional crosslinker of formula (III) “Alkoxysilane”, bis(trimethoxysilylpropyl)amine “Aminosilane 1”, and 3-(2-aminomethylamino)propyltriethoxysilane “Aminosilane 2”). Organotin compounds (“Sn-cat”) can be sourced from TIB under the TIB Kat® trade name.

As components A of the two-component silicone composition, the constituents listed in tables 1 and 2 were mixed with one another in the proportions by weight specified in a dissolver at room temperature under inert atmosphere, and stirred in until a macroscopically homogeneous paste was obtained.

As components B of the two-component silicone composition, the constituents listed in tables 1 to 4 were mixed with one another in the proportions by weight specified in a dissolver at room temperature under inert atmosphere, and stirred in until a macroscopically homogeneous paste was obtained.

Components A and B of the two-component silicone compositions that were produced were dispensed separately into cartridges, stored with sealing in air-tight manner and mixed with one another in a dissolver directly prior to application as specified in tables 1 to 4 in an A:B weight ratio of 13:1 until a macroscopically homogeneous paste was obtained.

The one-component silicone composition B-12 produced was produced by mixing the constituents listed in table 5 in the proportions by weight specified in a dissolver at room temperature under inert atmosphere, and stirring them in until a macroscopically homogeneous paste was obtained.

### Description of Test Methods

The method of determining elongation at break and tensile strength and the production of the test specimens required for the purpose are described in ISO 527. Measurement was effected at 23° C. and 50% relative air humidity on a type 1B test specimen (ISO 527-2) and with a tension rate of 200 mm/min.

The method of determining tear propagation resistance (TPR) and the production of the test specimens are required for the purpose is described in DIN ISO 34-1. Measurement was effected on type C test specimens.

The mixed viscosity of the uncured two-component compositions immediately after the components had been mixed was measured to DIN EN ISO 3219 on a Physica UM thermostatted cone-plate viscometer (cone diameter 20 mm, cone angle 1°, cone tip-plate distance 0.5 mm) at 23° C. and a shear rate of 0.89 s⁻¹).

TABLE 1

| Raw materials | B-1 | | V-1 | | B-2 | | V-2 | |
|---|---|---|---|---|---|---|---|---|
| Component A | % (A) | % | % (A) | % | % (A) | % | % (A) | % |
| OH-PDMS 1 (P2) | 35 | 32.50 | 40 | 37.14 | 37.5 | 34.82 | 32 | 29.71 |
| OH-PDMS 2 (P1) | 5 | 4.64 | — | — | 2.5 | 2.32 | 30 | 27.86 |
| PDMS oil | 25 | 23.21 | 25 | 23.21 | 25 | 23.21 | 21 | 19.5 |
| PCC | 35 | 32.50 | 35 | 32.50 | 20 | 18.57 | 9 | 8.36 |
| Silica 1 | — | — | — | — | 15 | 13.93 | 8 | 7.43 |
| Total (A) | 100 | 92.85 | 100 | 92.85 | 100 | 92.85 | 100 | 92.85 |
| P1:P2 (mol/mol) | 5 | | 0 | | 2.3 | | 32.8 | |
| Component B | % (B) | % | % (B) | % | % (B) | % | % (B) | % |
| Vinyl-PDMS | 43.5 | 3.11 | 43.5 | 3.11 | 43.5 | 3.11 | 44 | 3.14 |
| TEOS | 10.5 | 0.75 | 10.5 | 0.75 | 10.5 | 0.75 | 35 | 2.50 |
| TEOS-oligomer | — | — | — | — | — | — | 6 | 0.43 |
| Alkoxysilane | 20.5 | 1.46 | 20.5 | 1.46 | 20.5 | 1.46 | — | — |
| Aminosilane 1 | 5 | 0.36 | 5 | 0.36 | 5 | 0.36 | — | — |
| Aminosilane 2 | 5 | 0.36 | 5 | 0.36 | 5 | 0.36 | — | — |
| Silica 2 | 14.5 | 1.04 | 14.5 | 1.04 | 14.5 | 1.04 | 5 | 0.36 |
| Sn-cat | 1 | 0.07 | 1 | 0.07 | 1 | 0.07 | 10 | 0.71 |
| Total (B) | 100 | 7.15 | 100 | 7.15 | 100 | 7.15 | 100 | 7.15 |

| | | | | |
|---|---|---|---|---|
| TPR [N/mm] | 4 | 2.1 | 6 | 0.5 |

Inventive compositions (B-1, B-2) and reference compositions (V-1, V-2) in % by weight based on the overall composition (%) and based on the respective component (% (A) and % (B)) of two-component compositions, and the respective tear propagation resistances (TPRs) measured. The mixing ratio of component A to component B in all cases was 13:1.

TABLE 2

| Raw materials | B-3 | | B-4 | | B-5 | |
|---|---|---|---|---|---|---|
| Component A | % (A) | % | % (A) | % | % (A) | % |
| OH-PDMS 1 (P2) | 31 | 28.79 | 32.5 | 30.18 | 41.2 | 38.26 |
| OH-PDMS 2 (P1) | 2 | 1.86 | 7.5 | 6.96 | 5.9 | 5.48 |
| PDMS oil | 38.4 | 35.66 | 25 | 23.21 | 29.4 | 27.30 |
| PCC | 15.2 | 14.11 | 20 | 18.57 | — | — |
| Silica 1 | 13.4 | 12.44 | 15 | 13.93 | 23.5 | 21.82 |
| Total (A) | 100 | 92.85 | 100 | 92.85 | 100 | 92.85 |
| P1:P2 (mol/mol) | 2.3 | | 8.1 | | 5 | |
| Component B | % (B) | % | % (B) | % | % (B) | % |
| Vinyl-PDMS | 44 | 3.14 | 43.5 | 3.11 | 43.5 | 3.11 |
| TEOS | 35 | 2.50 | 10.5 | 0.75 | 10.5 | 0.75 |
| TEOS-oligomer | 6 | 0.43 | — | — | — | — |
| Alkoxysilane | — | — | 20.5 | 1.46 | 20.5 | 1.46 |
| Aminosilane 1 | — | — | 5 | 0.36 | 5 | 0.36 |
| Aminosilane 2 | — | — | 5 | 0.36 | 5 | 0.36 |
| Silica 2 | 5 | 0.36 | 14.5 | 1.04 | 14.5 | 1.04 |
| Sn-cat | 10 | 0.71 | 1 | 0.07 | 1 | 0.07 |
| Total (B) | 100 | 7.15 | 100 | 7.15 | 100 | 7.15 |

| | | | |
|---|---|---|---|
| TPR [N/mm] | 5.9 | 3.2 | 3.5 |

Inventive compositions (B-3 to B-5) in % by weight based on the overall composition (%) and based on the respective component (% (A) and % (B)) of two-component compositions, and the respective tear propagation resistances (TPRs) measured. The mixing ratio of component A to component B in all cases was 13:1.

TABLE 3

| Raw materials | B-6 | | B-7 | | B-8 | |
|---|---|---|---|---|---|---|
| Component A | % (A) | % | % (A) | % | % (A) | % |
| OH-PDMS 2 (P2) | — | — | — | — | 35 | 32.50 |
| OH-PDMS 5 (P2) | 35 | 32.50 | 35 | 32.50 | — | — |
| OH-PDMS 6 (P1) | 5 | 4.64 | 5 | 4.64 | 5 | 4.64 |
| PDMS oil | 25 | 23.21 | 25 | 23.21 | 25 | 23.21 |
| PCC | 35 | 32.50 | 35 | 32.50 | 35 | 32.50 |
| Total (A) | 100 | 92.86 | 100 | 92.86 | 100 | 92.86 |
| P1:P2 (mol/mol) | 0.37 | | 0.37 | | 0.32 | |
| Component B | % (B) | % | % (B) | % | % (B) | % |
| Vinyl-PDMS | 44.63 | 3.19 | 43.47 | 3.11 | 44.63 | 3.19 |
| TEOS | — | — | 10.26 | 0.73 | — | — |
| Alkoxysilane | 28.94 | 2.07 | 20.51 | 1.47 | 28.94 | 2.07 |
| Aminosilane 1 | 5.27 | 0.38 | 5.14 | 0.37 | 5.27 | 0.38 |
| Aminosilane 2 | 5.26 | 0.38 | 5.13 | 0.37 | 5.26 | 0.38 |
| Silica 2 | 14.85 | 1.06 | 14.46 | 1.03 | 14.85 | 1.06 |
| Sn-cat | 1.05 | 0.08 | 1.03 | 0.07 | 1.05 | 0.08 |
| Total (B) | 100 | 7.14 | 100 | 7.14 | 100 | 7.14 |

| | | | |
|---|---|---|---|
| TPR [N/mm] | 2.4 | 2.4 | 2.3 |

Inventive compositions (B-6 to B-8) in % by weight based on the overall composition (%) and based on the respective component (% (A) and % (B)) of two-component compositions, and the respective tear propagation resistances (TPRs) measured. The mixing ratio of component A to component B in all cases was 13:1.

TABLE 4

| Raw materials | B-9 | | B-10 | | B-11 | |
|---|---|---|---|---|---|---|
| Component A | % (A) | % | % (A) | % | % (A) | % |
| OH-PDMS 2 (P2) | 35 | 32.50 | 35 | 32.50 | 35 | 32.50 |
| OH-PDMS 1 (P1) | — | — | 5 | 4.64 | 5 | 4.64 |
| OH-PDMS 6 (P1) | 5 | 4.64 | — | — | — | — |
| PDMS oil | 25 | 23.21 | 25 | 23.21 | 25 | 23.21 |
| PCC | 35 | 32.50 | 35 | 32.50 | 35 | 32.50 |
| Total (A) | 100 | 92.86 | 100 | 92.86 | 100 | 92.86 |
| P1:P2 (mol/mol) | 0.32 | | 5 | | 5 | |
| Component B | % (B) | % | % (B) | % | % (B) | % |
| Vinyl-PDMS | 43.47 | 3.11 | 43.47 | 3.11 | 44.63 | 3.19 |
| TEOS | 10.26 | 0.73 | 10.26 | 0.73 | — | — |
| Alkoxysilane | 20.51 | 1.47 | 20.51 | 1.47 | 28.94 | 2.07 |
| Aminosilane 1 | 5.14 | 0.37 | 5.14 | 0.37 | 5.27 | 0.38 |
| Aminosilane 2 | 5.13 | 0.37 | 5.13 | 0.37 | 5.26 | 0.38 |
| Silica 2 | 14.46 | 1.03 | 14.46 | 1.03 | 14.85 | 1.06 |
| Sn-cat | 1.03 | 0.07 | 1.03 | 0.07 | 1.05 | 0.08 |
| Total (B) | 100 | 7.14 | 100 | 7.14 | 100 | 7.14 |

| | | | |
|---|---|---|---|
| TPR [N/mm] | 2.3 | 10.8 | 10.4 |

Inventive compositions (B-9 to B-11) in % by weight based on the overall composition (%) and based on the respective component (% (A) and % (B)) of two-component compositions, and the respective tear propagation resistances (TPRs) measured. The mixing ratio of component A to component B in all cases was 13:1.

TABLE 5
Inventive composition (B-12) in % by weight based on the overall
composition (%) of a one-component composition, and the
tear propagation resistance (TPR) measured.

| Raw materials | B-12 |
|---|---|
| OR-PDMS 3 (P2) | 35.80 |
| OR-PDMS 4 (P1) | 3.58 |
| PDMS oil | 10.74 |
| Methyltrimethoxysilane | 0.5 |
| 3-Aminopropyltrimethoxysilane | 0.97 |
| GCC | 44.75 |
| Silica 2 | 3.58 |
| Sn Cat | 0.09 |
| Total | 100 |
| P1:P2 (mol/mol) | 0.23 |
| TPR [N/mm] | 3.6 |

There follows a comparison (table 6) of the mixed viscosities of a conventional, non-inventive two-component (2K) silicone composition (Sikasil® SG-550, available from Sika Schweiz) with the inventive composition B-2 (as an industrial upscale test). For this purpose, the application rate of the 2K pumping system at pressure 200 bar is specified in order to compare pumpability.

TABLE 6
Mixed viscosity, TPR and application rate of an inventive
composition (B-2) and a commercially available
reference composition.

| | | Mixed | Application |
|---|---|---|---|
| | Tear | viscosity | rate of |
| | propagation | (components | 2K pumping |
| | resistance (TPR) | A + B) | system |
| Composition | [N/mm] | [mPa s] | at 200 bar [g/min] |
| B-2 (upscale) | 5.07 | 2015 | 800 |
| Sikasil ® SG-550 | 3.29 | 3378 | 300 |
| (reference) | | | |

1. A silicone composition comprising
at least two reactive polydiorganosiloxane polymers P1 and P2 of the formula (I) that together account for 20% to 60% by weight, based on the overall silicone composition, 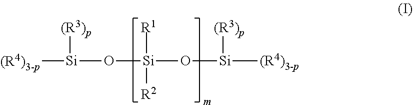
where the R¹, R² and R³ radicals are independently linear or branched, monovalent hydrocarbyl radicals which have 1 to 12 carbon atoms and optionally include one or more heteroatoms, and optionally one or more C—C multiple bonds and/or optionally cycloaliphatic and/or aromatic components;
the R⁴ radicals are independently hydroxyl groups or alkoxy, acetoxy or ketoxime groups which each have 1 to 13 carbon atoms and optionally include one or more heteroatoms, and optionally one or more C—C multiple bonds and/or optionally cycloaliphatic and/or aromatic components;
the index p has a value of 0, 1 or 2,
at least one crosslinker V for polydiorganosiloxanes, with a proportion of 0.5% to 5% by weight, based on the overall silicone composition,
at least one catalyst K, with a proportion of 0.001% to 0.1% by weight, based on the overall silicone composition,
at least one optionally hydrophobized filler F, selected from precipitated or fumed silica and ground or precipitated chalk, with a proportion of 10% to 70% by weight, based on the overall silicone composition,
wherein
the reactive polyorganosiloxane polymer P1 has a higher reactivity in the condensation crosslinking with crosslinker V than the reactive polyorganosiloxane polymer P2 and the molar ratio P1:P2 in the composition is between 0.1 and 15.

2. The silicone composition as claimed in claim 1, wherein the R¹ and R² radicals are methyl groups and the R³ radicals are independently phenyl, vinyl or methyl groups.

3. The silicone composition as claimed in claim 1, wherein the reactive polydiorganosiloxane polymer P1 has an average molecular weight Mₙ of between 500 and 3000 g/mol and the reactive polydiorganosiloxane polymer P2 has an average molecular weight Mₙ of between 50,000 and 250,000 g/mol.

4. The silicone composition as claimed in claim 1, wherein the reactive polydiorganosiloxane polymer P1 has different reactive silane functions.

5. The silicone composition as claimed in claim 1, wherein the filler F comprises two fillers F1 and F2, where one filler F1 has a BET surface area of between 5 and 50 m²/g and the other filler F2 has a BET surface area of between 50 and 300 m²/g.

6. The silicone composition as claimed claim 1, wherein the catalyst K comprises at least one complex of an element selected from groups 1, 4, 8, 9, 10, 12, 13, 14 and 15 of the Periodic Table.

7. The silicone composition as claimed in claim 1, wherein the crosslinker V comprises two or more organosilanes and/or hydrolyzates and/or condensates thereof.

8. The silicone composition as claimed in claim 1, wherein the composition is a one-component silicone composition.

9. The silicone composition as claimed in claim 1, wherein the composition is a two-component silicone composition consisting of a component A comprising
the at least two reactive polydiorganosiloxane polymers P1 and P2 that together account for 20% to 60% by weight, based on the overall silicone composition,
the at least one optionally hydrophobized filler F, selected from precipitated or fumed silica and ground or precipitated chalk, with a proportion of 10% to 70% by weight, based on the overall silicone composition;
and a component B comprising
the at least one crosslinker V for polydiorganosiloxanes, with a proportion of 0.5% to 5% by weight, based on the overall silicone composition,
the at least one catalyst K, with a proportion of 0.001% to 0.1% by weight, based on the overall silicone composition.

10. The silicone composition as claimed in claim 9, wherein the weight ratio of component A to component B is ≥1:1.

11. A method comprising bonding substrates by applying two reactive polydiorganosiloxane polymers P1 and P2, where the reactive polyorganosiloxane polymer P1 has a higher reactivity in condensation crosslinking with a crosslinker V for polydiorganosiloxanes than the reactive polyorganosiloxane polymer P2 and the molar ratio P1:P2 in the composition is between 0.1 and 15, together with at least one filler F selected from precipitated or fumed silica and ground or precipitated chalk, with at least one crosslinker V, and with a catalyst K for increasing the tear propagation resistance of silicone compositions.

12. The method according to claim 11, wherein the filler F is a filler combination of F1 and F2, comprising, as F2, at least one silica having a BET surface area of 50 to 300 m²/g and, as F1, at least one chalk having a BET surface area of 10 to 25 m²/g.

13. A method comprising applying the silicone composition as claimed in claim 1 as adhesive, sealant, coating or casting compound.

14. A cured silicone composition obtainable from a one-component silicone composition as claimed in claim 8.

15. A built construction or fabricated article that has been bonded, sealed, cast or coated with a silicone composition as claimed in claim 1.

16. A cured silicone composition obtainable from a two-component silicone composition as claimed in claim 9 by mixing component A with component B.
